(19) United States
(12) Patent Application Publication
(10) Pub. No.: US 2019/0153185 A1
(43) Pub. Date: May 23, 2019

(54) METHOD FOR PRODUCING SANDWICH COMPONENTS

(71) Applicants: BASF SE, Ludwigshafen am Rhein (DE); Construction Research & Technology GmbH, Trostberg (DE)

(72) Inventors: Sven MOENNIG, Mannheim (DE); Sarunas TURCINSKAS, Trostberg (DE); Dirk WEINRICH, Lemfoerde (DE); Andrea EISENHARDT, Lemfoerde (DE); Christian RENNER, Lemfoerde (DE); Juergen BOKERN, Mannheim (DE); Alex POPOV, Lemfoerde (DE); Gianpaolo TOMASI, Lemfoerde (DE)

(21) Appl. No.: 16/098,050

(22) PCT Filed: May 30, 2017
(86) PCT No.: PCT/EP2017/062983

§ 371 Date: Oct. 31, 2018

(30) Foreign Application Priority Data
May 30, 2016 (EP) 16172046.1

(51) Int. Cl. C08J 9/12; B32B 5/20; B32B 13/04; B32B 13/12; B29C 39/12; B29C 44/12; B29C 44/34; C08G 18/76; C08G 18/48; C08J 9/14; E04C 2/288

(52) U.S. Cl. CPC C08J 9/127; B29K 2075/00; B32B 13/045; B32B 13/12; B29C 39/126; B29C 44/1228; B29C 44/129; B29C 44/3442; C08G 18/7671; C08G 18/4829; C08J 9/125; C08J 9/146; E04C 2/288; B32B 2250/03; B32B 2250/40; B32B 2266/0278; B32B 2307/72; B32B 2607/00; B32B 5/20

(57) ABSTRACT

The invention relates to a sandwich component composed of at least two building material plates which are arranged essentially parallel to one another at a distance from one another and have a polyurethane foam core between the spaced building material plates, wherein the ratio of the greatest measured compressive modulus of the polyurethane foam core in a direction oriented parallel to the building material plates to the compressive modulus of the polyurethane foam core in a direction oriented perpendicular to the building material plates is less than 1.7. To produce the sandwich components, a mixture of (a) at least one polyisocyanate component, (b) at least one component which comprises at least one polyfunctional compound which is reactive toward isocyanates and (c) at least one blowing agent is introduced by the high-pressure injection method into a hollow space between spaced building material plates. The process makes it possible to produce sandwich components whose foam core has reduced anisotropy combined with good insulation values.

The invention relates to a process for producing sandwich components composed of at least two building material plates which are at a distance from one another and have a polyurethane foam core arranged between the building material plates, and also the sandwich components obtainable by the process.

Sandwich components composed of at least two building material plates, e.g. concrete plates, which are at a distance from one another and have a foam core which acts as insulating layer located inbetween are known. Thus, WO 00/15685 and WO 2009/077490 describe a component having a rigid polyurethane foam as insulating layer. By means of such sandwich constructions, attempts are made to meet the requirements in respect of load bearing capability, thermal insulation, durability and sustainability which modern building shells have to meet. To produce the sandwich components, prefabricated rigid foam boards composed of polyurethane are used and are manually placed between the building material plates or the foam cores are foamed-in between the concrete plates, with foaming-in being effected by pouring, see Bauingenieur 88, 412-419 and Composite Structures 121 (2015) 271-279. In addition, laminating polyurethane plates with a laminated-on aluminum foil is known. In this way, the polyurethane plates can be made diffusion-impermeable and more aging resistant.

Ali Shams et al. in Composite Structures 121 (2015) 271-279 disclose the production of sandwich elements, wherein liquid polyurethane material is poured between two concrete plates fixed in a mold, the mold is closed and the foam is cured.

The foam cores of the known sandwich components have unavoidable anisotropy, i.e. the mechanical properties vary with the orientation of the foam. This anisotropy results directly from the process for producing the foam cores. The foams usually have different mechanical properties in the main expansion direction (rise direction) of the foam than in a direction perpendicular thereto. The cells grow differently in the rise direction than perpendicular to the rise direction. To obtain uniform mechanical properties which are independent of the orientation, foam cores having low anisotropy are desirable. Excessive anisotropy of the foam core can also impair the thermal insulation properties of the sandwich component.

The manufacturing times for the sandwich components produced according to the prior art are too long for effective industrial manufacture. Since the manufacturing time to production of the insulation is significantly above the cycle time for producing the sandwich elements themselves, it is necessary according to the prior art to carry out insulation as a process step outside the manufacturing cycle for the sandwich elements, which makes production uneconomical. In addition, cracks are formed in the (brittle) building material plates during introduction of foam because of the buildup of pressure, which leads to reduced durability and reduced tensile adhesive strength of the foam on the building material plate and to increased diffusion of the cell gas from the foam. The consequence of this is a reduced insulating effect of the sandwich components.

It is therefore an object of the present invention to provide sandwich components whose foam core has reduced anisotropy combined with good insulation values, and also a process for producing the sandwich components which can be carried out with a fast manufacturing time.

This object is achieved by a sandwich component composed of at least two building material plates which are arranged essentially parallel to one another at a distance from one another and have a polyurethane foam core between the spaced building material plates, wherein the ratio of the greatest measured compressive modulus (in accordance with DIN EN ISO 844) of the polyurethane foam core in a direction oriented parallel to the building material plates to the compressive modulus of the polyurethane foam core in a direction oriented perpendicular to the building material plates is less than 1.7, more preferably less than 1.5.

The core density of the polyurethane foam core is preferably in the range from 20 to 100 kg/m³, in particular from 20 to 80 kg/m³ and particularly preferably from 30 to 60 kg/m³ or from 30 to 50 kg/m³. Here, the core density (in kg/m³) is measured using a cube having an edge length of about 5 cm from the middle part of the foam.

This object is also achieved by a process for producing sandwich components composed of at least two building material plates which are at a distance from one another and have a polyurethane foam core, comprising the following steps:
A) mixing of (a) at least one polyisocyanate component, (b) at least one component which comprises at least one polyfunctional compound which is reactive toward isocyanates and (c) a blowing agent by the high-pressure injection process;
B) introduction of the mixture obtained into a hollow space between the spaced building material plates, where the compaction of the foam is in the range from 1.1 to 2.5, where the compaction is the ratio of the density of the foam in the hollow space divided by the density of the free-foamed foam body.

It has been found that the foam cores produced with defined compaction by the high-pressure injection process have, at good insulation values, a lower anisotropy than free-foamed foam cores. Due to the method of construction, the mechanical properties of the sandwich components in the direction of the thickness, i.e. in a direction oriented perpendicular to the building material plates, are particularly important. In the case of the sandwich components of the invention, the ratio of the greatest measured compressive modulus of the polyurethane foam core in a direction oriented parallel to the building material plates to the compressive modulus of the polyurethane foam core in a direction oriented perpendicular to the building material plates is less than 1.7, preferably less than 1.5. The ratio of the greatest measured compressive modulus of the polyurethane foam core in a direction oriented parallel to the building material plates to the compressive modulus of the polyurethane foam core in a direction oriented perpendicular to the building material plates is preferably from 0.58 to <1.7, in particular from 0.66 to <1.5. The direction in which the greatest compressive modulus of the polyurethane foam core is measured is typically parallel to the rise direction of the foam during production.

For the purposes of the present invention, the expression “comprising” also encompasses the expression “consisting of”. Percentages should be understood in such a way that the sum of all percentages of the constituents of a formulation is 100%. Unless indicated otherwise, all percentages are based on the total weight of a formulation. The following statements relate both to sandwich components according to the invention and to the production process of the invention, unless the context indicates otherwise.

Step A):

In step A), a polyisocyanate component (a) which comprises at least one polyisocyanate (al) is mixed with a component (b) which comprises at least one polyfunctional compound (b1) which is reactive toward isocyanates in order to bring about formation of a polyurethane. In the context of the present invention, a polyisocyanate (a1) is an organic compound which comprises at least two reactive isocyanate groups per molecule, i.e. the functionality is at least 2. If the polyisocyanates used or a mixture of a plurality of polyisocyanates do not have a uniform functionality, the weight average of the functionality of the component (a1) used is at least 2.

Possible polyisocyanates (a1) are the aliphatic, cycloaliphatic, araliphatic and preferably aromatic polyfunctional isocyanates which are known per se. Such polyfunctional isocyanates are known per se or can be prepared by methods known per se. The polyfunctional isocyanates can, in particular, also be used as mixtures so that the component a) in this case comprises various polyfunctional isocyanates. Polyfunctional isocyanates coming into question as polyisocyanate have two (hereinafter referred to as diisocyanates) or more than two isocyanate groups per molecule.

Specifically, mention may be made of, in particular: alkylene diisocyanates having from 4 to 12 carbon atoms in the alkylene radical, e.g. dodecane 1,12-diisocyanate, tetramethylene 1,4-diisocyanate, 2-ethyl-tetrametylene 1,4-diisocyanate, pentamethylene 1,5-diisocyanate, 2-methylpentamethylene 1,5-diisocyanate and preferably hexamethylene 1,6-diisocyanate; cycloaliphatic diisocyanates such as cyclohexane 1,3- and 1,4-diisocyanate and any mixtures of these isomers, 1-isocyanato-3,3,5-trimethyl-5-isocyanatomethylcyclohexane (IPDI), hexahydrotolylene 2,4- and 2,6-diisocyanate and the corresponding isomer mixtures, dicyclohexylmethane 4,4′-, 2,2′- and 2,4′-diisocyanate and the corresponding isomer mixtures, and preferably aromatic polyisocyanates such as tolylene 2,4- and 2,6-diisocyanate and the corresponding isomer mixtures, diphenylmethane 4,4′-, 2,4′- and 2,2′-diisocyanate and the corresponding isomer mixtures, mixtures of diphenylmethane 4,4′- and 2,2′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates.

Particularly suitable are diphenylmethane 2,2′-, 2,4′- and/or 4,4′-diisocyanate (MDI), naphthylene 1,5-diisocyanate (NDI), tolylene 2,4- and/or 2,6-diisocyanate (TDI), 3,3′-dimethyl-biphenyl diisocyanate, diphenylethane 1,2-diisocyanate and/or p-phenylene diisocyanate (PPDI), trimethylene, tetramethylene, pentamethylene, hexamethylene, heptamethylene and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and dicyclohexylmethane 4,4′-, 2,4′- and/or 2,2′-diisocyanate.

Use is frequently also made of modified polyisocyanates, i.e. products which are obtained by chemical reaction of organic polyisocyanates and have at least two reactive isocyanate groups per molecule. Particular mention may be made of polyisocyanates comprising ester, urea, biuret, allophanate, carbodiimide, isocyanurate, uretdione, carbamate and/or urethane groups.

Particular preference is given to the following embodiments:
i) polyfunctional isocyanates based on tolylene diisocyanate (TDI), in particular 2,4-TDI or 2,6-TDI or mixtures of 2,4- and 2,6-TDI;
ii) polyfunctional isocyanates based on diphenylmethane diisocyanate (MDI), in particular 2,2′-MDI or 2,4′-MDI or 4,4′-MDI or oligomeric MDI, which is also referred to as polyphenylpolymethylene isocyanate, or mixtures of two or three of the abovementioned diphenylmethane diisocyanates, or crude MDI which is obtained in the preparation of MDI or mixtures of at least one oligomer of MDI and at least one of the abovementioned low molecular weight MDI derivatives;
iii) mixtures of at least one aromatic isocyanate as per embodiment i) and at least one aromatic isocyanate as per embodiment ii);
   as polyisocyanates (a1) of the component a).

Polymeric diphenylmethane diisocyanate is very particularly preferred as polyisocyanate. Polymeric diphenylmethane diisocyanate (hereinafter referred to as polymeric MDI) is a mixture of two-ring MDI and oligomeric condensation products and thus derivatives of diphenylmethane diisocyanate (MDI). The polyisocyanates can preferably also be made up of mixtures of monomeric aromatic diisocyanates and polymeric MDI.

Polymeric MDI comprises not only two-ring MDI but also one or more multi-ring condensation products of MDI having a functionality of more than 2, in particular 3 or 4 or 5. Polymeric MDI is known and is frequently referred to as polyphenylpolymethylene isocyanate or as oligomeric MDI. Polymeric MDI is usually made up of a mixture of MDI-based isocyanates having different functionalities. Polymeric MDI is usually used in a mixture with monomeric MDI.

The (weight average) functionality of a polyisocyanate which comprises polymeric MDI can vary in the range from about 2.2 to about 5, in particular from 2.3 to 4, in particular from 2.4 to 3.5. Such a mixture of MDI-based polyfunctional isocyanates having different functionalities is, in particular, crude MDI which is obtained as intermediate in the preparation of MDI.

Polyfunctional isocyanates or mixtures of a plurality of polyfunctional isocyanates based on MDI are known and are marketed, for example, by BASF Polyurethanes GmbH under the name Lupranat®.

The functionality of the polyisocyanate (a1) is preferably at least 2, in particular at least 2.2 and particularly preferably at least 2.4. The functionality is preferably from 2.2 to 4 and particularly preferably from 2.4 to 3.

The content of isocyanate groups in the polyisocyanate (a1) is preferably from 5 to 10 mmol/g, in particular from 6 to 9 mmol/g, particularly preferably from 7 to 8.5 mmol/g. A person skilled in the art will know that the content of isocyanate groups in mmol/g and the equivalent weight in g/equivalent are reciprocals of one another. The content of isocyanate groups in mmol/g can be derived from the content in percent by weight in accordance with ASTM D-5155-96 A.

In a particularly preferred embodiment, the component a) comprises at least one polyfunctional isocyanate selected from among diphenylmethane 4,4′-diisocyanate, diphenylmethane 2,4′-diisocyanate, diphenylmethane 2,2′-diisocyanate and oligomeric diphenylmethane diisocyanate. In the context of this preferred embodiment, the component (a) particularly preferably comprises oligomeric diphenylmethane diisocyanate and has a functionality of at least 2.4.

The viscosity of the component a) used can vary within a wide range. The component a) preferably has a viscosity of from 100 to 3000 mPa·s, particularly preferably from 200 to 2500 mPa·s.

In a particularly preferred embodiment, a mixture of diphenylmethane 1,4′-diisocyanate with higher-functional oligomers and isomers (crude MDI) having an NCO content of from 20 to 40% by mass, preferably from 25 to 35% by mass, for example 31.5% by mass, and an average functionality of from 2 to 4, preferably from 2.5 to 3.5, for example about 2.7, is present as component a).

In the polyurethane foam obtained, the polyisocyanate (a1) is generally present in an amount of from 100 to 250% by weight, preferably from 160 to 200% by weight, particularly preferably from 170 to 190% by weight, in each case based on the sum of the components (a) and (b).

According to the invention, component b) comprises at least one polyfunctional compound (b1) which is reactive toward isocyanates. Polyfunctional compounds which are reactive toward isocyanates are compounds which have at least two hydrogen atoms which are reactive toward isocyanates, in particular at least two functional groups which are reactive toward isocyanates.

The compounds (b1) used in the component b) preferably have a functionality of from 2 to 8, in particular from 2 to 6. If a plurality of different compounds are used as component b), the weight average functionality of the compound (b1) is preferably from 2.2 to 5, particularly preferably from 2.4 to 4, very particularly preferably from 2.6 to 3.8. The weight average functionality is understood to be the value which results when the functionality of every compound (b1) is weighted by the proportion by weight of this compound in the component b).

Polyols and especially polyether polyols are preferred as compounds (b1). The term polyether polyol is used synonymously with the term polyetherol and denotes alkoxylated compounds having at least two reactive hydroxyl groups.

Preferred polyether polyols (b1) have a functionality of from 2 to 8 and have hydroxyl numbers of from 100 mg KOH/g to 1200 mg KOH/g, preferably from 150 to 800 mg KOH/g, in particular from 200 mg KOH/g to 550 mg KOH/g. All hydroxyl numbers in the present invention are determined in accordance with DIN 53240.

In general, the proportion of the polyfunctional compound which is reactive toward isocyanates is, based on the total weight of the component b), from 40 to 98% by weight, preferably from 50 to 97% by weight, particularly preferably from 60 to 95% by weight.

The polyetherols (b1) which are preferred for component b) can be prepared by known methods, for example by anionic polymerization of one or more alkylene oxides having from 2 to 4 carbon atoms in the presence of alkali metal hydroxides such as sodium or potassium hydroxide, alkali metal alkoxides such as sodium methoxide, sodium or potassium ethoxide or potassium isopropoxide or amine alkoxylation catalysts such as dimethylethanolamine (DMEOA), imidazole and/or imidazole derivatives using at least one starter molecule comprising from 2 to 8, preferably from 2 to 6, reactive hydrogen atoms in bound form, or by cationic polymerization in the presence of Lewis acids such as antimony pentachloride, boron fluoride etherate or bleaching earth.

Suitable alkylene oxides are, for example, tetrahydrofuran, 1,3-propylene oxide, 1,2- or 2,3-butylene oxide, styrene oxide and preferably ethylene oxide and 1,2-propylene oxide. The alkylene oxides can be used individually, alternately in succession or as mixtures. Particularly preferred alkylene oxides are 1,2-propylene oxide and ethylene oxide.

Component b) preferably comprises at least one polyether polyol having a hydroxyl number of from 200 to 400 mg KOH/g, in particular from 230 to 350 mg KOH/g, and a functionality of from 2 to 3. The abovementioned ranges ensure good flow behavior of the reactive polyurethane mixture.

The component b) can additionally comprise at least one polyether polyol having a hydroxyl number of from 300 to 600 mg KOH/g, in particular from 350 to 550 mg KOH/g, and a functionality of from 4 to 8, in particular from 4 to 6. The abovementioned ranges lead to good chemical crosslinking of the reactive polyurethane mixture.

Possible starter molecules are, for example: water, organic dicarboxylic acids such as succinic acid, adipic acid, phthalic acid and terephthalic acid, aliphatic and aromatic, optionally N-monoalkyl-, N,N-dialkyl- and N,N′-dialkyl-substituted diamines having from 1 to 4 carbon atoms in the alkyl radical, for example optionally mono- and dialkyl-substituted ethylenediamine, diethylenetriamine, triethylene-tetramine, 1,4-propylenediamine, 1,3- or 1,4-butylene-diamine, 1,2-, 1,3-, 1,4-, 1,5- and 1,6-hexamethylene-diamine, phenylenediamines, 2,3-, 2,4- and 2,6-tolylene-diamine and 4,4′-, 2,4′- and 2,2′-diaminodiphenylmethane. Particular preference is given to the diprimary amines mentioned, for example ethylenediamine.

Further suitable starter molecules are: alkanolamines such as ethanolamine, N-methylethanolamine and N-ethyl-ethanolamine, dialkanolamines such as diethanolamine, N-methyldiethanolamine and N-ethyldiethanolamine and trialkanolamines such as triethanolamine and ammonia.

Preference is given to using dihydric or polyhydric alcohols such as ethanediol, 1,2- and 1,3-propanediol, diethylene glycol (DEG), dipropylene glycol, 1,4-butanediol, 1,6-hexanediol, glycerol, trimethylol-propane, pentaerythritol, sorbitol and sucrose.

Furthermore, polyester alcohols having hydroxyl numbers of from 100 to 1200 mg KOH/g are possible as compounds (b1).

Preferred polyester alcohols are prepared by condensation of polyfunctional alcohols, preferably diols, having from 2 to 12 carbon atoms, preferably from 2 to 6 carbon atoms, with polyfunctional carboxylic acids having from 2 to 12 carbon atoms, for example succinic acid, glutaric acid, adipic acid, suberic acid, azelaic acid, sebacic acid, decane-dicarboxylic acid, maleic acid, fumaric acid and preferably phthalic acid, isophthalic acid, terephthalic acid and the isomeric naphthalenedicarboxylic acids.

Further information on the preferred polyether alcohols and polyester alcohols and the preparation thereof may be found, for example, in Kunststoffhandbuch, Volume 7 “Polyurethane”, edited by Gunter Oertel, Carl-Hanser-Verlag Munich, 3^{rd} edition, 1993.

Furthermore, at least one blowing agent (c) is added in step A). The blowing agent can be comprised in the component A), but preferably in the component b).

As blowing agents, it is generally possible to use the blowing agents known to those skilled in the art, for example water and/or carboxylic acids, in particular formic acid which reacts with isocyanate groups to eliminate carbon dioxide (chemical blowing agent). It is also possible to use physical blowing agents. These are compounds which are inert toward the starting components and are usually liquid at room temperature and vaporize under the conditions of the urethane reaction. The boiling point of these compounds is preferably below 50° C. Physical blowing agents also include compounds which are gaseous at room temperature and are introduced under pressure into the starting components or are dissolved therein, for example carbon dioxide, low-boiling alkanes and fluoroalkanes. The compounds are preferably selected from the group consisting of C₃-C₅-alkanes, C₄-C₆-cycloalkanes, di-C₁-C₄-alkyl ethers, esters, ketones, acetals, fluoroalkanes having from 1 to 8 carbon atoms and tetraalkylsilanes having from 1 to 3 carbon atoms in the alkyl chain, in particular tetramethylsilane. Examples which may be mentioned are propane, n-butane, isobutane, cyclo-butane, n-pentane, isopentane, cyclopentane, cyclo-hexane, dimethyl ether, methyl ethyl ether, methyl butyl ether, diethyl ether, methyl formate, dimethyl oxalate, ethyl acetate, acetone, methyl ethyl ketone and also C₂-C₄-fluoroalkanes which can be degraded in the troposphere and therefore do not damage the ozone layer. Examples of blowing agents are trifluoromethane, difluoromethane, dichloromethane, 1,1,1,3,3-penta-fluorobutane, 1,1,1,3,3-pentafluoropropane, 1,1,1,2-tetrafluoroethane, difluoroethane and heptafluoropropane, dichloromonofluoromethane, chlorodifluoro-ethanes, 1,1-dichloro-2,2,2-trifluoroethane, 1,1,1,3,3-pentafluoropropane, 2,2-dichloro-2-fluoroethane and heptafluoropropane and also partially halogenated C₂-C₄-fluoroolefins such as trans-1,3,3,3-tetrafluoroprop-1-ene (HFO-1234ze) 3,3,3-trifluoro-1-chloroprop-1-ene (HFO-1233d), 2,3,3,3-tetrafluoroprop-1-ene (HFO-1234yf), FEA 1100 (1,1,1,4,4,4-hexafluoro-2-butene) and FEA 1200. The physical blowing agents mentioned can be used either alone or in any combinations with one another.

Preferred blowing agents are formic acid, halogenated hydrocarbons, partially halogenated fluorohydrocarbons, water or mixtures thereof.

The blowing agent is generally present in the polyurethane foam in an amount of from 1 to 25% by weight, preferably from 2 to 10% by weight, in each case based on the sum of the components (a) and (b).

Preference is also given to adding at least one catalyst (d) in step A). The catalyst is generally comprised in the component b), preferably together with the blowing agent (c). As catalysts for producing the polyurethane foam cores, use is made of, in particular, compounds which strongly accelerate the reaction of the compounds (b1) comprising reactive hydrogen atoms, in particular hydroxyl groups, of the component (b) with the polyisocyanates (a1).

Basic polyurethane catalysts, for example tertiary amines such as triethylamine, tributylamine, dimethylbenzylamine, dicyclohexylmethylamine, dimethylcyclohexylamine, bis(N,N-dimethylaminoethyl) ether, bis(dimethylaminopropyl)urea, N-methylmorpholine or N-ethylmorpholine, N-cyclohexylmorpholine, N,N,N′,N′-tetramethylethylenediamine, N,N,N,N-tetramethylbutane-diamine, N,N,N,N-tetramethylhexane-1,6-diamine, pentamethyldiethylenetriamine, bis(2-dimethylaminoethyl) ether, dimethylpiperazine, N-dimethylaminoethylpiperidine, 1,2-dimethylimidazole, 1-azabicyclo[2.2.0]octane, 1,4-diazabicyclo[2.2.2]octane (Dabco) and alkanolamine compounds such as triethanolamine, triisopropanolamine, N-methyldiethanolamine and N-ethyldiethanolamine, dimethylaminoethanol, 2-(N,N-dimethylaminoethoxy)ethanol, N,N′,N″-tris(dialkylaminoalkyl)hexahydrotriazines, e.g. N,N′,N″-tris(dimethylaminopropyl)-s-hexahydrotriazine, and triethylenediamine are advantageously used. However, metal salts such as iron(II) chloride, zinc chloride, lead octoate and preferably tin salts such as tin dioctoate, tin diethylhexanoate and dibutyltin dilaurate and also, in particular, mixtures of tertiary amines and organic tin salts are also suitable.

Further possible catalysts are: amidines such as 2,3-dimethyl-3,4,5,6-tetrahydropyrimidine, tetraalkylammonium hydroxides such as tetramethylammonium hydroxide, alkali metal hydroxides such as sodium hydroxide and alkali metal alkoxides such as sodium methoxide and potassium isopropoxide, alkali metal carboxylates and also alkali metal salts of long-chain fatty acids having from 10 to 20 carbon atoms and optionally lateral OH groups. Preference is given to using from 0.001 to 10 parts by weight of catalyst or catalyst combination, based on (i.e. calculated on the basis of) 100 parts by weight of the component (b1). It is also possible to allow the reactions to proceed without catalysis. In this case, the catalytic activity of polyols initiated using amines is exploited.

If a large excess of polyisocyanate is used for foaming, further suitable catalysts for the trimerization reaction of the excess NCO groups with one another are: catalysts which form isocyanurate groups, for example ammonium ions or alkali metal salts, especially ammonium or alkali metal carboxylates, either alone or in combination with tertiary amines. Isocyanurate formation leads to particularly flame-resistant PIR foams.

Further information on the starting materials mentioned and further starting materials may be found in the specialist literature, for example in Kunststoffhandbuch, Volume VII, Polyurethane, Carl Hanser Verlag Munich, Vienna, 1^{st}, 2^{nd} and 3^{rd} edition 1966, 1983 and 1993.

At least one chain extender (e) is optionally also used in step A). The chain extender is preferably employed as a constituent of the component b). Chain extenders are understood to be compounds which have a molecular weight of from 60 to 400 g/mol and have two hydrogen atoms which are reactive toward isocyanates. Examples are butanediol, diethylene glycol, dipropylene glycol and ethylene glycol.

The chain extenders (e) are generally used in an amount of from 2 to 20% by weight, based on the sum of the components (a), (b), (c) and (d).

At least one crosslinker (f) is optionally also used in step A). The crosslinker is preferably employed as constituent of the component b). Preference is given to using alkanolamines and in particular diols and/or triols having molecular weights of less than 400, preferably from 60 to 300, as crosslinkers.

Crosslinkers are generally used in an amount of from 1 to 10% by weight, preferably from 2 to 6% by weight, based on the sum of the components a) and b).

Crosslinkers and chain extenders can be used individually or in combination. The addition of chain extenders and/or crosslinkers can be advantageous for modifying the mechanical properties.

The component (b) can also comprise further customary additives (g), for example surface-active substances, stabilizers such as foam stabilizers, cell regulators, fillers, dyes, pigments, flame retardants, antistatics, hydrolysis inhibitors, fungistatic and bacteriostatic substances and mixtures thereof.

Suitable flame retardants are generally the flame retardants known from the prior art, for example brominated ethers (Ixol), brominated alcohols such as dibromoneopentyl alcohol, tribromoneopentyl alcohol and PHT 4-diol and also chlorinated phosphates such as tris(2-chloroethyl) phosphate, tris(2-chloroisopropyl) phosphate (TCPP), tris(1,3-dichloroisopropyl) phosphate, tris(2,3-dibromopropyl) phosphate and tetrakis(2-chloroethyl)ethylene diphosphate.

As further liquid halogen-free flame retardants, it is possible to use diethyl ethanephosphonate (DEEP), triethyl phosphate (TEP), dimethyl propylphosphonate (DMPP), diphenyl cresyl phosphate (DPC) and others.

The flame retardants are generally used in an amount of from 2 to 65% by weight, preferably from 5 to 60% by weight, more preferably from 5 to 50% by weight, based on the sum of the components (a) and (b).

The ratio of OCN groups to OH groups, known as the ISO index, in the reaction mixture for producing the polyurethane foam of the invention is from 140 to 180, preferably from 145 to 165, particularly preferably from 150 to 160. This ISO index ensures that a polyurethane foam which has a particularly advantageous combination of low thermal conductivity and thermal stability is obtained.

The mixing of the components (a) and (b) is carried out by the high-pressure injection method in the one-shot process or multishot process. In this mixing principle, the components flow at high velocity into a mixing chamber and are mixed there utilizing the kinetic energy on passage through. The mixing chamber is preferably operated in countercurrent. It is possible to use one or more mixing heads and the hollow space between the building material plates can be divided into a plurality of cavities. The components (a) and (b) can comprise organic solvents but are preferably used without solvents. The components (a) and (b) are metered into the mixing chamber at a pressure of at least 100 bar, in particular at a pressure in the range from 100 bar to 300 bar. Further information on the high-pressure injection method may be found in the specialist literature, for example in Kunststoffhandbuch, Volume VII, Polyurethane, Carl Hanser Verlag Munich, Vienna, 3^{rd} edition 1993.

The mixing of the components (a) and (b) is generally carried out at a temperature in the range from 5 to 70° C., in particular from 10 to 50° C.

Step B):

The not yet foamed mixture exiting from the mixing chamber is introduced into a hollow space between two building material plates. The faces of the building material plates are at a distance from one another and are arranged substantially parallel to one another, so that a hollow space which accommodates the foam core is present between the plates. The upright or horizontal building material plates are advantageously held in place by external shuttering. The distance between the building material plates is generally set by means of spacers, for example composed of polymer. In general, the spacing is in the range from 1 to 30 cm, preferably from 4 to 22 cm, in particular from 8 to 20 cm, i.e. the thickness of the polyurethane foam core (insulating layer) has a corresponding value.

The amount of mixture introduced into the hollow space depends on the size of the hollow space. In general, the amount is such that the overall injected foam density is less than 100 kg/m³, in particular less than 80 kg/m³. The overall injected foam density is preferably in the range from 20 to 100 kg/m³, preferably from 20 to 80 kg/m³ and in particular from 30 to 60 kg/m³ or from 30 to 50 kg/m³. The overall injected foam density is to be understood as the total amount of mixture from step A) which is introduced divided by the total volume of the foam in the hollow space.

The high-pressure injection process enables the mixture to be produced from the components (a) and (b) and to be introduced in the hollow space in large quantities and within a short period of time. The process therefore contributes significantly to the economic production of the sandwich components. It is generally possible to introduce the mixture into the hollow space in quantities in the range from 0.1 to 8 kg/s, preferably 1 to 8 kg/s, and in particular 2 to 8 kg/s.

The building material plates are, in particular, made of inorganic mineral materials. Examples are concrete plates, gypsum plaster plates and plates composed of geopolymers. For producing the concrete plates, it is possible to use all conventional cements, in particular Portland cement, together with the usual additives. Possible cements also include latent hydraulic binders such as industrial and synthetic slags, in particular blast furnace slag, precipitated silica, pyrogenic silica, microsilica, metakaolin, aluminosilicates or mixtures thereof. Gypsum plaster plates are usually made of gypsum-comprising materials such as mortar gypsum, machine gypsum, stucco plaster, etc. Geopolymers which are used for producing geopolymer plates are inorganic binder systems which are based on reactive water-insoluble compounds based on SiO₂ and Al₂O₃, e.g. microsilica, metakaolin, aluminosilicates, fly ash, activated clays, pozzolanic materials or mixtures thereof and cure in an aqueous alkali medium. Geopolymers are described, for example, in U.S. Pat. No. 4,349,386, WO 85/03699 and U.S. Pat. No. 4,472,199.

The building plates can also comprise fibers, textiles or reinforcement. For the fibers, textiles or reinforcement, it is possible to use customary materials which can consist of polymer or metal. The tensile strength of the building material plates is improved by these additives.

The dimensions of the building material plates can be selected within a wide range. Sizes of up to 3.5 m×15 mm at a thickness of up to 15 cm are possible.

In a preferred embodiment, at least one of the building material plates is at least partly provided with a layer of a primer, in particular over the entire area, on the side facing the hollow space. It is advantageous to provide both building material plates with the primer.

For the present purposes, a primer is a coating which is obtained by application and curing of a composition which comprises an organic binder. The organic binder can be a physically curing or chemically curing binder. Physically curing binders are solutions of polymers in organic solvents and/or water. Curing then occurs by evaporation of the water and/or the organic solvent. Binders which are curable by means of a chemical reaction are monomeric, oligomeric or polymeric compounds which have chemically reactive groups and are introduced in pure form or as a solution in water or in a suitable organic solvent into the composition. The reactive groups then make, by means of a chemical reaction, the organic binder cure over a period of from a few hours to 30 days to form polymeric structures. The organic binder can be introduced as a one-component system or as a two-component or multicomponent system. In the case of one-component systems, chemical groups which are reactive toward one another are present side-by-side in the system. Activation for the reaction then occurs via a switching or triggering mechanism, for example by a change in the pH, by radiation with short-wavelength light, by introduction of heat or by oxidation by means of atmospheric oxygen. In the case of two-component or multicomponent systems, the monomers, oligomers or polymers which are able to react with one another are firstly present separately. Only as a result of mixing of the components is the organic binder activated and the buildup of molecular weight can take place by means of chemical reactions. A combination of film formation and crosslinking can also occur in the organic binder.

Suitable organic binders are known to those skilled in the art; for example, it is possible to use polyurethanes, polyureas, polyacrylates, polystyrenes, polystyrene copolymers, polyvinyl acetates, polyethers, alkyd resins or epoxy resins. Physically curing binders are aqueous dispersions, for example acrylate dispersions, ethylene-vinyl acetate dispersions, polyurethane dispersions or styrene-butadiene dispersions. Suitable chemically curing one-component systems are, for example, polyurethanes or alkyd resins. As chemically curing two-component or multicomponent systems, it is possible to use, for example, epoxy resins, polyurethanes, polyureas. Organic binders which can display a combinations of film formation and crosslinking are, for example, post-crosslinking acrylate dispersions or post-crosslinking alkyd resin dispersions.

In one embodiment, the primer comprises epoxy resins such as epoxy resins based on bisphenol, e.g. bisphenol A, Novolak epoxy resins, aliphatic epoxy resins or halogenated epoxy resins. In the case of epoxy resins, in particular those based on bisphenol or in the case of Novolak epoxy resins, the organic binder is generally a monomer or oligomer, preferably having up to four units, which has at least two diglycidyl units. Curing is effected by addition of a hardener, generally polyamines such as 1,3-diaminobenzene, diethylene-triamine, etc.

In one embodiment, the epoxy resins comprise reactive diluents such as monoglycidyl ethers, for example glycidyl ethers of monohydric phenols or alcohols, or polyglycidyl ethers which have at least two epoxide groups.

The coating to be applied to the building material plates can additionally comprise customary constituents such as solvents, antifoams, fillers, pigments, dispersing additives, rheology regulators, light stabilizers or mixtures thereof. The composition can be applied by spraying, doctor blade coating, brushing, rolling directly onto the mineral substrate of the building material plate.

The primer is generally applied in an amount of from 20 to 600 g/m², e.g. from 50 to 600 g/m².

Further information on suitable epoxy resins may be found, for example, in Ullmann's Encyclopedia of Industrial Chemistry, 5^{th} edition, vol. A9, page 547.

After introduction of the mixture of the components (a) and (b) into the hollow space between the building material plates, foaming of the mixture occurs as a result of the action of the blowing agent to form a polyurethane foam. A foam having a compaction which is in the range from 1.2 to 2.5, in particular from 1.25 to 2.5, is obtained. Compaction is understood to be the quotient of the density of the foam in the hollow space divided by the density of the corresponding uncompacted (free-foamed) foam. The density of the foam can be controlled via the amount of foam introduced or via the amount of the blowing agent. The overall foam density of the foam core is generally in the range from 20 to 100 kg/m³, preferably from 20 to 80 kg/m³ and in particular from 30 to 60 kg/m³ or from 30 to 50 kg/m³.

The foam is a rigid foam which generally completely fills the hollow space. The process of the invention makes economical production of insulated sandwich components possible with a short cycle time. It is therefore no longer necessary to carry out the insulating step outside the manufacturing cycle of the sandwich components themselves, but instead can be carried out in-factory in the production of the sandwich components. In addition, it has surprisingly been found that reinforcement of the building material plates can be dispensed with when using the process of the invention because the strength of the sandwich components is improved in comparison to the sandwich components produced without reinforcement according to the prior art. Finally, it has been found that, due to the stable bond between concrete plates and primer, spacers can be dispensed with so that the insulating action is improved still further.

The present invention therefore also provides a sandwich component which is obtainable by means of the process of the invention. In one embodiment, the foam of the sandwich component has a thermal conductivity in the range from 16 to 30 mW/m·K, in particular from 22 to 28 mW/m·K. This is the thermal conductivity of the fresh foam, determined in accordance with DIN EN 14318-1 after 1-8 days after preconditioning at (23±3)° C. and a relative atmospheric humidity of (50±10)% for 16 hours, measured in a direction oriented perpendicular to the building material plates.

The sandwich components can be employed in a conventional manner as, inter alia, load-bearing wall elements, non-load-bearing wall elements, for example as exterior wall cladding, and as ceiling elements.

The accompanying figures and the following examples illustrate the invention.

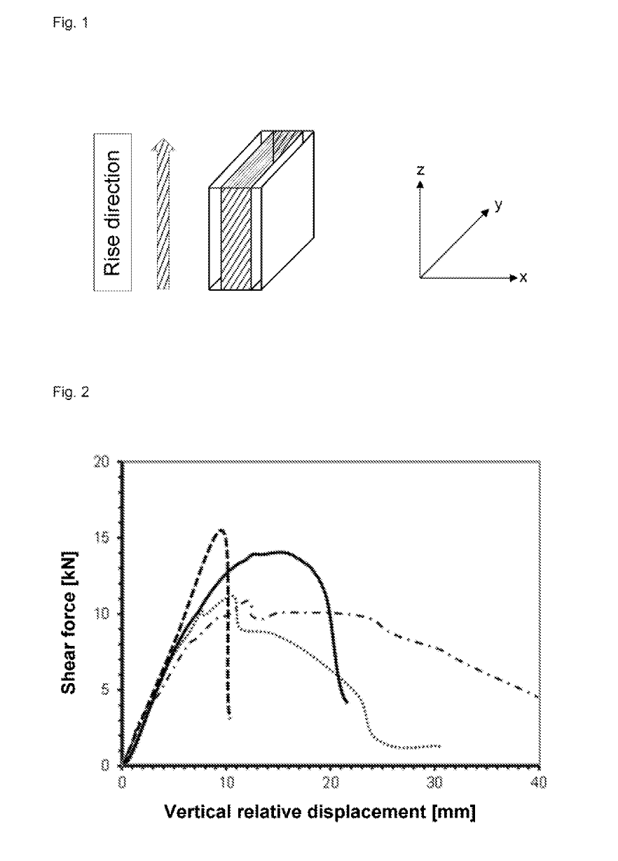

FIG. 1 shows a definition of the directions in space which are employed for defining the PU foams.

FIG. 2 shows load-displacement curves of various sandwich elements.

With regard to FIG. 1, two building material plates are arranged at a distance from one another and substantially parallel to one another so that a hollow space which accommodates the foam core is present between the plates. Here, x denotes a direction which is oriented perpendicular to the building material plates, z denotes the rise direction of the foam and y denotes a direction which is oriented parallel to the building material plates and perpendicular to the rise direction.

### EXAMPLE 1

In the following examples, an epoxy primer or in example d) a PU primer was used as primer. The primer was in all experiments applied manually to the concrete (brush or roller) and dried overnight before the PU reaction mixture was introduced.

The polyurethane foam (PU foam) used had a proportion of closed cells of 91% and was in each case produced on the basis of polymeric MDI and polyether polyol and water and/or HFC 245FA (1,1,1,3,3-pentafluoropropane) as blowing agent.

The following concretes were used:

Concrete 1: Based on cement (CEM I 52.5 R); compressive strength 55 MPa.

Concrete 2: Based on cement (CEM I 32.5 N); compressive strength 29 MPa.

Concrete 3: Based on cement (CEM III/B 42.5 NW/MS/NA); compressive strength 81.9 MPa

The compressive strengths (in a direction oriented perpendicular to the building material plates) were determined in accordance with DIN EN 1048.

a) CO₂ Diffusion with and without Primer

For this test, concrete cubes having an edge length of 15 cm and concrete prisms (12×12×36 cm³) were produced from concrete 1.

The CO₂ diffusion/carbonatization was carried out at a CO₂ content of 4%, a relative humidity of 57% and a temperature of 20° C. using a method based on the Swiss standard SN 505 262/1 (appendix I). These values are actively regulated in a carbonatization chamber. The preliminary storage of the test specimens according to this standard after removal from the formwork was storage in water up to the 3^{rd} day and then storage at 20° C. and 57% relative humidity for 25 days. The reason for this is to allow the concrete to dry during this conditioning and not too much moisture is thus introduced into the carbonatization chambers. 500 g/m² of the epoxy primer were applied to half of the test specimens.

To determine the carbonatization depth, a slice was split off from the prisms and the new fracture surface was sprayed with phenolphthalein. The carbonatized region does not discolor, while the region which has not been carbonatized takes on a pink color. The carbonatization depth is determined at five places on each side of the prism. This gives 20 measurements per age. The carbonatization depth is determined before the test specimens are placed in the chambers and also after 7, 28 and 63 days. Because the mortar carbonatizes very quickly, the carbonatization depth was determined there after 0, 7, 14, 21 and 46 days in the carbonatization chamber. The carbonatization coefficient KN was calculated as follows:

dK=A+KS·t1/2

KN=a·b·c·KS

KN=carbonatization coefficient under natural conditions with a CO₂ content of 0.04% [mm/√year]

a=conversion from 1 day to 1 year (365/1)1/2=19.10

b=conversion factor from 4.0 to 0.04% by volume of CO₂

c=correction factor for quick carbonatization

| | CO₂ absorption coefficient |
|---|---|
| Material | KN/[mm/√year] |
| Concrete, uncoated | 12.5 |
| (without primer) | |
| Concrete, coated | 0.0 |
| (with primer - 500 g/m²) | |

b) Tensile Bond Strengths with and without Primer

Direct tensile bond strengths with and without primer indicate a significantly higher strength in the case of the test specimens made of concrete 2 with primer. A prefoamed PU foam (slabstock foam) introduced on primer between two concrete plates achieves tensile bond strengths of about 0.14 N/mm², while a PU foam foamed without primer between two concrete plates (HDI methods; high-pressure metering apparatus; pressure>120 bar) and having a density of 50 g/l attains about 0.16 N/mm² and a PU foam foamed with primer by the HDI method attains about 0.20 N/mm². At higher densities of the PU foam and when using a primer, rupture of the foam itself occurs, depending on the strength of the concrete.

Example I) with Primer, Concrete 2:

with PU foam having a density of 50 g/l: failure of the PU foam at 0.20 N/mm²

with PU foam having a density of 100 g/l: failure of the concrete test specimen at 0.23 N/mm²

Example II) with Primer, Concrete 3:

Concrete strength 81.9 MPa

with PU foam having a density of 90 g/l: failure of the foam at 0.32 N/mm²

c) Load/Deformation with and without High-Pressure Injection

To determine the load-bearing capability of the sandwich element having a PU foam core between plates of concrete 1, load-displacement curves were measured under a shear stress. Test specimens: cut from the sandwich elements. Dimensions 25×25 cm×2.5 cm concrete plates, 15 cm foam thickness. The results are shown in graph form in FIG. 2. In the case of a PU slabstock foam adhesively bonded in, sudden failure of the composite occurs: the foam delaminates from the sandwich element (broken line). All foams introduced by the HDI method display ductile failure, i.e. at the same load, greater and more uniform deformation, rather than sudden failure, occurs.

Broken line: Slabstock foam as plate having a density of 50 g/l (compaction 1.0) adhesively bonded in using PU

Building foam: max. load 15 kN and max. deformation 10 mm

Black: Injection foam having a density of 50 g/l (compaction about 1.5) with primer: max. load about 15 kN and max. deformation 20 mm

Dot-dash: Injection foam having a density of 30 g/l (compaction about 1.3) without primer: max. load about 10 kN and max. deformation>40 mm

Dots: Injection foam having a density of 50 g/l (compaction about 1.5) without primer: max. load about 10 kN and max. deformation 25 mm

d) Thermal Conductivity with and without Primer

The primers were an epoxy primer and a PU primer.

The sandwiches are produced with two concrete test specimens and rigid PU foam in the middle. The open sides are lined with vacuum packaging film in the mold.

Dimensions of concrete shells: 20×20×2.0 cm

Foam volume between the concrete shells: 20×20×6 cm (2.4 1)

The open sides are lined with VIP film (vacuum insulation panel) in the mold.

Plates composed of PU foam are protected against outward diffusion of cell gases by means of laminated-on aluminum foil having a thickness of 80 μm (reference). Exchange of the cell gas can likewise be prevented by use of an epoxy primer (concrete system) with a thickness of 500 g/m². The results shown are measured thermal conductivities (T.C.) after accelerated aging, i.e. storage at 60° C. for 42 days.

| | Thermal conductivity |
|---|---|
| | [mW/m · K] |
| PU foam with VIP film lamination | 23.1 |
| PU foam without lamination | 26.7 |
| Concrete element, not predried, | 23.1 |
| with epoxy primer 500 g/m² | |
| Concrete element, predried, with | 23.7 |
| epoxy primer 500 g/m² | |
| Concrete element, predried, with | 26.3 |
| PU primer 500 g/m² | |
| Concrete element, predried, | 25.5 |
| without primer | |

### EXAMPLE 2

### Anisotropy Studies

Three test specimens were produced. A volume of 20×20×6 cm³ (2.4 1) which was bounded by 2 cm thick concrete plates was filled with a polyurethane foam. The polyurethane foam (PU foam) used was produced on the basis of polymeric MDI and polyether polyol and formic acid, 1,1,1,3,3-pentafluorobutane and 1,1,1,3,3-penta-fluoropropane as blowing agents.

The specimen “compacted, FD 45” was foamed by means of high-pressure injection foam having a compaction of about 1.35. The overall injected foam density (amount of liquid polyurethane material introduced divided by the total volume of the volume filled with foam) was about 45 kg/m3.

The specimen “free, FD 45” was free-foamed by filling with poured foam. The amount of blowing agents was reduced so that an overall injected foam density of about 45 kg/m³ was attained.

The specimen “free, FD 38” was free-foamed by filling with poured foam. The composition of the liquid polyurethane material corresponded to the specimen “compacted, FD 45”; owing to the lack of compaction, an overall injected foam density of only about 38 kg/m³ was obtained.

Square parallelepipeds of 5×5 cm² and a thickness of 50 mm were cut in three directions in space from the foam bodies obtained. The mechanical properties of the test specimens in the thickness direction of the parallelepipeds was examined in accordance with DIN EN ISO 844.

The compressive strength [N/mm²] and compressive modulus were determined at 10% compression/min.

The thermal conductivity was determined in accordance with DIN EN 12667. The results are summarized in the following table (Std. dev.=standard deviation).

TABLE

| | Compacted, FD45 | | | Free, FD45 | | | Free, FD38 | | |
|---|---|---|---|---|---|---|---|---|---|
| | Perpendicular to the | | | Perpendicular to the | | | Perpendicular to the | | |
| | covering layer (x) | | | covering layer (x) | | | covering layer (x) | | |
| Test feature | Average | Std. dev. | Unit | Average | Std. dev. | Unit | Average | Std. dev. | Unit |
| Compressive | 0.085 | 0.004 | N/mm² | 0.092 | 0.008 | N/mm² | 0.046 | 0.003 | N/mm² |
| strength/stress | | | | | | | | | |
| Compression | 10.0 | 0.0 | % | 7.1 | 2.4 | % | 10.0 | 0.1 | % |
| Compressive | 2.7 | 0.34 | N/mm² | 2.82 | 0.40 | N/mm² | 1.18 | 0.03 | N/mm² |
| modulus | | | | | | | | | |
| Thermal | 21.8 | 0.0 | mW/m*K | 22.4 | 0.0 | mW/m*K | 21.9 | 0.0 | mW/m*K |
| conductivity | | | | | | | | | |

| | Parallel to the rise | | | Parallel to the rise | | | Parallel to the rise | | |
|---|---|---|---|---|---|---|---|---|---|
| | direction (z) | | | direction (z) | | | direction (z) | | |
| Test feature | Average | Std. dev. | Unit | Average | Std. dev. | Unit | Average | Std. dev. | Unit |
| Compressive | 0.100 | 0.018 | N/mm² | 0.208 | 0.002 | N/mm² | 0.122 | 0.002 | N/mm² |
| strength/stress | | | | | | | | | |
| Compression | 7.9 | 1.8 | % | 4.4 | 0.2 | % | 4.3 | 0.3 | % |
| Compressive | 2.66 | 0.56 | N/mm² | 6.99 | 0.06 | N/mm² | 3.95 | 0.26 | N/mm² |
| modulus | | | | | | | | | |
| | Third direction/width (y) | | | Third direction/width (y) | | | Third direction/width (y) | | |
| Test feature | Average | Std. dev. | Unit | Average | Std. dev. | Unit | Average | Std. dev. | Unit |
| Compressive | 0.093 | 0.014 | N/mm² | 0.117 | 0.015 | N/mm² | 0.102 | 0.005 | N/mm² |
| strength/stress | | | | | | | | | |
| Compression | 6.7 | 2.9 | % | 9.0 | 1.0 | % | 6.9 | 2.6 | % |
| Compressive | 2.54 | 0.52 | N/mm² | 2.95 | 0.80 | N/mm² | 2.87 | 0.17 | N/mm² |
| modulus | | | | | | | | | |

The specimen “compacted, FD 45” shows low anisotropy (ratio of compressive modulus parallel to the rise direction/perpendicular to the covering layer=1.18) and a good insulation value of 21.8 mW/m*K. The specimen “free, FD 45” has a comparable compressive strength perpendicular to the covering layer, but displays a poorer thermal insulation value. The specimen “free, FD 38” has an unsatisfactory compressive strength perpendicular to the covering layer.

1. A sandwich component comprising at least two building material plates which are arranged essentially parallel to one another at a distance from one another and have a polyurethane foam core between the spaced building material plates, wherein the ratio of the greatest measured compressive modulus of the polyurethane foam core in a direction oriented parallel to the building material plates to the compressive modulus of the polyurethane foam core in a direction oriented perpendicular to the building material plates is less than 1.7.

2. The sandwich component according to claim 1, wherein the core density of the polyurethane foam core is in the range from 20 to 100 kg/m³.

3. The sandwich component according to claim 1, wherein at least one of the building material plates is provided at least partly with a primer on the side facing the polyurethane foam core.

4. The sandwich component according to claim 1, wherein the building material plates are made of concrete, geopolymers or gypsum plaster.

5. The sandwich component according to claim 1, wherein the fresh foam of the sandwich component has a thermal conductivity in the range from 16 to 30 mW/m·K.

6. A process for producing sandwich components comprising at least two building material plates which are at a distance from one another and have a polyurethane foam core, comprising the following steps:
A) mixing of (a) at least one polyisocyanate component, (b) at least one component which comprises at least one polyfunctional compound which is reactive toward isocyanates and (c) at least one blowing agent by the high-pressure injection process to form a mixture; and
B) introducing the mixture obtained into a hollow space between the spaced building material plates, where the compaction of the foam is in the range from 1.1 to 2.5, where the compaction is the ratio of the density of the foam in the hollow space divided by the density of the free-foamed foam body.

7. The process according to claim 6, wherein the mixing of the components (a) to (c) is carried out in a mixing chamber at a pressure of at least 100 bar.

8. The process according to claim 6, wherein the blowing agent is selected from C₃-C₅-alkanes, C₄-C₆-cycloalkanes, di-C₁-C₄-alkyl ethers, methyl formate, formic acid, acetone, fluorohydrocarbons, partially halogenated fluoroolefins, chlorofluorocarbons, carbon dioxide, water and mixtures of two or more thereof.

9. The process according to claim 6, wherein at least one catalyst for the reaction of the polyisocyanate component with the polyol component is added in step A).

10. The process according to claim 6, wherein the amount of the mixture introduced into the hollow space in step B) is such that the overall injected foam density is less than 100 kg/m³, where the overall injected foam density is the total amount of mixture from step A) which is introduced divided by the total volume of the hollow space to be filled with foam.

11. The process according to claim 6, wherein the amount of mixture introduced into the hollow space in step B) is in the range from 0.1 to 8 kg/s.

12. The process according to claim 6, wherein at least one of the building material plates is provided at least partly with a primer on the side facing the hollow space.

13. The process according to claim 12, wherein the primer is based on a physically setting binder and/or a chemically curing binder.

14. The process according to claim 13, wherein the primer is based on a binder selected from among an epoxy resin, post-crosslinking acrylate dispersions or post-crosslinking alkyd resin dispersions.

15. The process according to claim 12, wherein the primer is applied in an amount in the range from 20 to 600 g/m².

16. The process according to claim 6, wherein the building material plates are made of concrete, geopolymers or gypsum plaster.

17. The sandwich component according to claim 1, wherein the fresh foam of the sandwich component has a thermal conductivity in the range from 22 to 28 mW/m·K.

18. The process according to claim 6, wherein the mixing of the components (a) to (c) is carried out in a mixing chamber at a pressure in the range from 100 bar to 300 bar.

19. The process according to claim 6, wherein the amount of the mixture introduced into the hollow space in step B) is such that the overall injected foam density is less than 80 kg/m³.
